(19) United States
(12) Patent Application Publication
(10) Pub. No.: US 2005/0060382 A1
(43) Pub. Date: Mar. 17, 2005

(54) On-Demand Electronic Documents Processing and Sharing

(76) Inventors: Alex Spector, San Diego, CA (US); Michael Morozov, San Diego, CA (US); Igor Proshkin, San Diego, CA (US)

Correspondence Address: JEFFREY FURR, 253 N. MAIN STREET, JOHNSTOWN, OH, 43031, US

(21) Appl. No.: 10/605,211

(22) Filed: Sep. 15, 2003

(51) Int. Cl. G06F 15/167

(52) U.S. Cl. 709/213

(57) ABSTRACT

The present invention is an apparatus, method, and computer program product for on-demand document processing and sharing. A digital file is perceived as a “shared document” which is distributed to viewers. The invention includes the just-in-time processing of the shared document according to certain viewing preferences submitted by viewers and sending the shared document to one or more remote computers, where the shared document is displayed by a viewer application.

### BACKGROUND OF INVENTION

The primary field of this invention is electronic documents processing and sharing in a distributed network, such as Internet.

### BACKGROUND OF THE INVENTION PRIOR ART

In prior art, there are three basic ways of electronic document sharing:

1. Share-point server, wherein documents are uploaded to a centralized location (a server) and are sent (served) to spectators (viewers) from that server.

2. Peer-to-peer networks, wherein documents are stored on individual host computers and are served directly from one host computer to another.

3. A combined method, wherein the central server has a dynamic searchable directory of host computers, which is used to locate the electronic documents and initiate peer-to-peer transfer of electronic documents between host computers.

The choice of the method typically depends on the type of electronic documents that are being shared.

First method is best for smaller documents, such as text documents, small images and web pages. A community web server is a perfect example of the first approach. The major drawback of this approach is the necessity to upload the documents and substantial network traffic generated by document transfer to/from a single location.

The second method improves on the first method by distributing the network traffic and dismissing the need to upload the documents. It is often used for exchange of the larger documents, such as large images, audio and video files. The main drawback of this second approach is slow search times and subsequently a limit on the number of reachable clients. All pure peer-to-peer networks have a so-called “search horizon”, representing a number of clients that can be reached and searched from any particular location in a reasonable amount of time. Another drawback is that peer-to-peer client software must be installed on the spectator's computer in order to find, request and receive the electronic documents.

The third method further improves on the second method by providing the centralized directory, which improves the search times, but the host software still needs to be installed on the spectator's computer.

There is yet another problem concerned with the shared documents themselves. All mentioned methods are useful for sharing of static documents. However many types of documents may have a number of views. For example, a compressed sound file, video file or digital image can have different degrees of quality level, which affects the size of the shared file. Sharing users are forced to prepare the electronic documents for sharing and to sacrifice quality to reach acceptable file size. Resulting electronic documents are nothing more than a single view of the original document. A good example would be a scaled down digital image created from a larger original for upload or a sound file compressed at a certain bit-rate for faster downloading in a peer-to-peer environment. Neither of the abovementioned sharing methods allows for storage of the original document and dynamic generation of specific views according to the spectator's request.

The need for a file sharing method that allows for storage of the original document and dynamic generation of specific view shows that there is still room for improvement within the art.

### SUMMARY OF INVENTION

The present invention is an apparatus, method, and computer program product for on-demand document processing and sharing. In one embodiment, referred to as “image sharing,” a digital image file is perceived as a “shared document” which is distributed to viewers. The method of this embodiment includes processing of the image file according to certain viewing preferences submitted by viewers and sending the shared document to one or more remote computers, where the shared document is displayed by a viewer application.

In other embodiments referred to as “document sharing,” the “owner” of a document shares the file with arbitrary data which is processed according to applicable rules and delivered to viewers in applicable form.

Further features and advantages of the present invention as well as the structure and operation of various embodiments of the present invention are described in detail below with reference to the accompanying drawings.

### OBJECTIVES AND ADVANTAGES

The purpose of this invention is to improve on the abovementioned sharing methods in a way that:

1. No upload is necessary. Electronic documents are sent directly from host computers to the spectators.

2. No document preparation is necessary. All documents are stored in their original form.

3. Spectators have control over the viewing preferences. On-demand processing software is installed on host computers, which creates specific views of documents depending on the spectator's viewing preferences.

4. There is no need to install proprietary host software in order to receive the shared electronic documents. Common protocols, such as Hyper Text Transfer Protocol (HTTP), File Transfer Protocol (FTP) are used to transfer electronic documents to the spectators. HTTP and FTP protocols are widely used for World Wide Web surfing and data exchange.

Our invention removes the three bottlenecks of the sharing process:

1. Document preparation (pre-processing)

2. All necessary processing occurs automatically and just in time on per-request basis

3. Both sharing and receiving parties are completely freed from any kind of document manipulation or communication with each other

Our invention shall tremendously simplify the sharing process for both sharing users and viewing parties. The process of sharing becomes as easy as storing the original electronic document at a certain location on the host computer, where it can be picked up by the proposed processing and delivery software. The viewers are given the flexibility of requesting and receiving electronic documents formatted according to their individual preferences.

The novelty of our approach becomes apparent in the light of these advantages:

1. Document preparation, processing and transfer are postponed until there is a specific request for a specific view of the document.

2. All necessary processing occurs automatically and just in time on per-request basis3s

3. Both sharing and receiving parties are completely freed from any kind of document manipulation or communication with each other

### BRIEF DESCRIPTION OF DRAWINGS

The present invention will be described with reference to the accompanying drawings.

FIG. 1 establishes the relationship between server and host components as well as shared documents, sharing hosts and spectators;

FIG. 2 is a flow diagram depicting the operation of electronic document request and delivery;

FIG. 3 depicts possible architecture of server software;

FIG. 4 depicts possible architecture of host software; and

FIG. 5 depicts an example computer system capable of carrying out the functionality of the present invention.

### DRAWINGS—REFERENCE NUMERALS

202—Spectator

204—Host2O6—Server

208—Host computer

210—Spectator's computer

300—Server application

302—Host interface

304—Synchronization service

306—Central database

308—Viewer interface

400—Host application

402—Shared documents folder

404—Watchdog service

406—Delivery interface

408—Processing service

410—Manipulated documents cache

500—Computer system

504—Processor

506—System bus

508—Main memory

510—Secondary memory

512—Hard disk drive

514—Removable storage drive

518—Removable storage unit

520—Removable storage interface

522—Removable storage unit

524—Communications interface

526—Communication signal

528—Communication channel

### DETAILED DESCRIPTION

The present invention is described in terms of the above example of image sharing. This is for convenience only and is not intended to limit the application of the present invention. In fact, after reading the following description, it will be apparent to one skilled in the relevant art how to implement the present invention in alternative embodiments.

Introduction

The present invention is an apparatus, method, and computer program product for sharing documents in a network having multiple remote clients. The present invention is usually invoked after a network connection has been established between all involved clients and the server. Methods for establishing network connection among clients are well-known in the relevant arts.

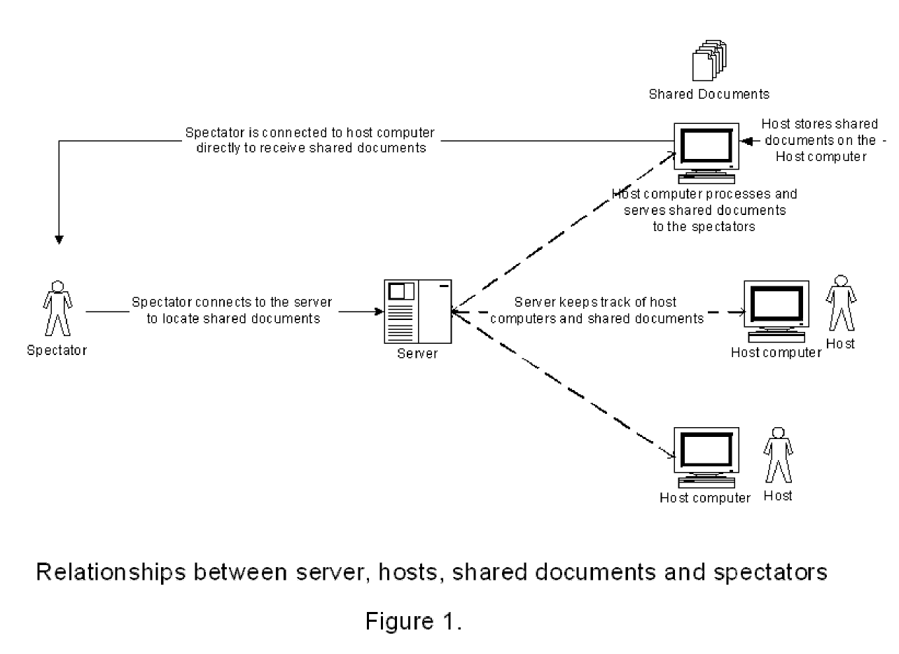

In the present invention a client assumes one of two roles: host and spectator. The host is client that provides the document. A spectator is a client that can view the document. The relationships between spectators, hosts and various components of the proposed system are depicted on FIG. 1.

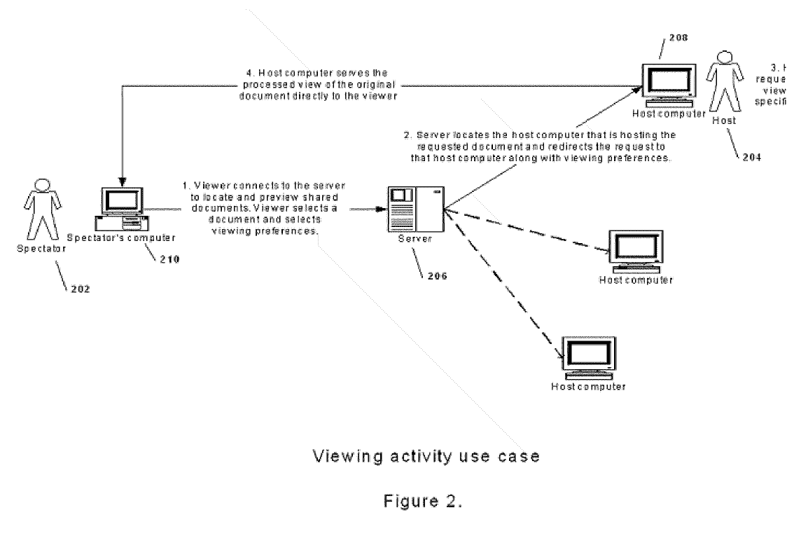

FIG. 2 depicts two clients 202 and 204 engaged in a document sharing using a spectator's computer 210, a server 206 and a host computer 208. Client 204 has assumed the role of host and client 202 has assumed the role of spectator. One key advantage of using a combination of client-server and peer-to-peer architecture is that server is not burdened with document processing and delivery to all spectators. It merely relays the requests for documents to host computers. On the other hand spectators are not burdened with installation of peer-to-peer software, nor need they be aware of where the documents are really delivered from. For all intents and purposes spectators have an impression of being connected only to the server. This advantage permits the system to be highly scalable yet very simple to use for all involved parties.

Referring to FIG. 2, each host PC 208 includes an operating system, such as Windows, a memory, and a host document processing and sharing application.

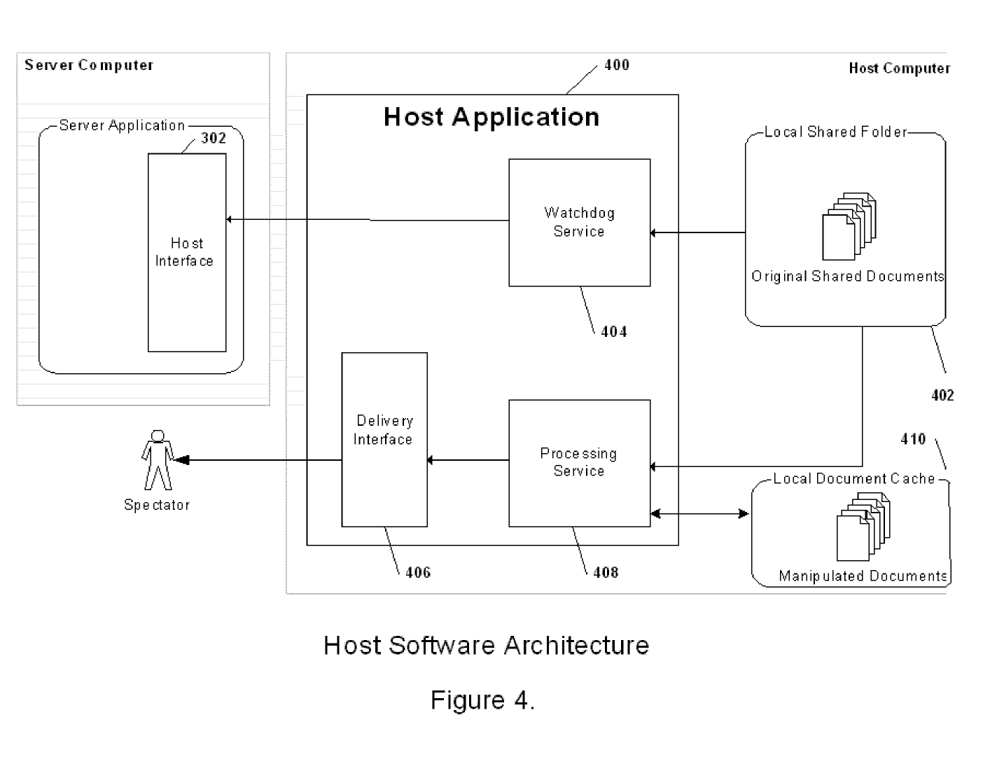

FIG. 4 depicts possible architecture of the host document processing and sharing application according to a preferred embodiment of the present invention. In a preferred embodiment, document processing and sharing application is configured as a standalone application that can be downloaded from the Internet and installed on a computer running a Windows-type operating system. Spectator's PC 210 includes an operating system (not necessarily Windows), a memory, and a browser such as Windows Internet Explorer or Netscape Navigator capable of running in the selected operating system.

It is assumed that host has already made the shared document available as described below.

Sharing

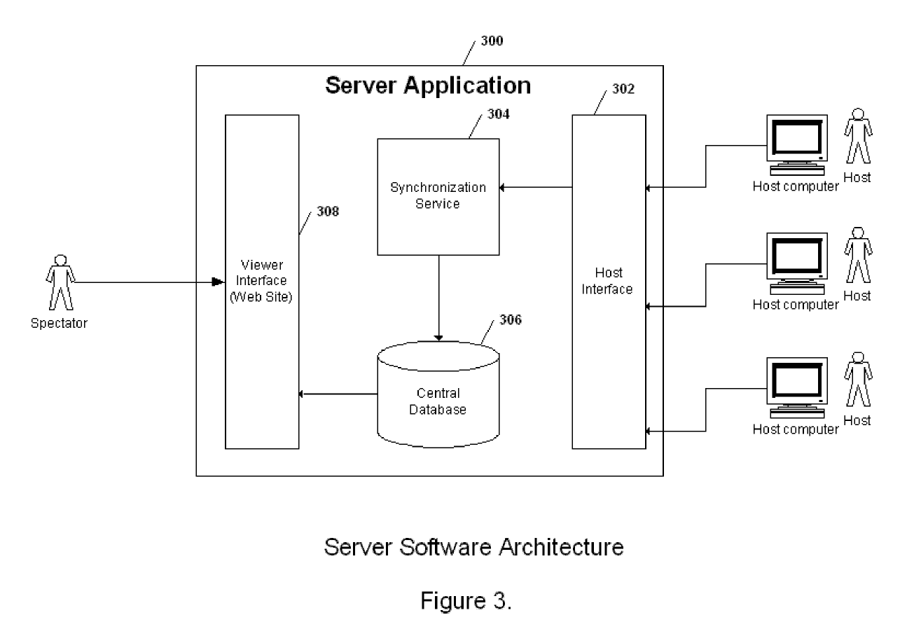

As shown in FIG. 4, in order to share a document, document is placed into a special folder 402, where it can be found by the host application 400. Application 400 is able to monitor the shared folder by means of a watchdog service 404. Upon discovery of any changes in the shared documents folder, the host application notifies the server application software 300 depicted on the FIG. 3. via its host interface 302. The server application 300 invokes its synchronization service 304, which requests a preview image of the document from the host software via the viewer interface 406. Alternatively, the transfer of preview images can be initiated by the host application. This approach is well-known in the relevant arts as “content pushing”.

The preview image is stored in the central database 306 along with information regarding the location of shared images. Spectators can search and browse the central database via the viewer interface 308. For the purpose of this preferred embodiment the viewer interface is implemented as a web site and is accessible to spectators via a known Internet address.

All described processes are automatically initiated by simply placing the document into the shared folder. No other action is required from the host but to store the shared documents in the predefined folder. It is a radical improvement compared to other methods of sharing that involve pre-processing and uploading of documents.

When the server requests the preview image from the host computer it simply assumes the role of spectator and receives the preview image by the same method of viewing, which is described in detail below.

Viewing

As shown in FIG. 3 and FIG. 4, in order to view the documents spectators access the previously known web site to locate the document and to select the viewing preferences. When spectator is requesting a certain document, the server application 300 extracts the information about the document's location from the central database 306 and forms a request to the host application 400 on the appropriate host computer. This request includes the identifier of the requested document and selected viewing preferences.

In the preferred embodiment the viewing preferences include the dimensions of the requested image and the compression quality. Note that these preferences can be selected by the spectator knowingly or determined automatically based on the spectator's screen size and connection speed. One of the possible applications of automatic determination of viewing preferences is viewer-independent full-screen display of images. This particular feature is not an obligatory part of this invention, but rather an additional benefit made possible by the architecture of the proposed system and method of sharing. In other embodiments the viewing preferences may include the file format for text documents, compression bit-rate for compressed sound and video files or any other parameters applicable to the selected type of shared document.

The request is received by the host's delivery interface 406. In response to this incoming request the host application 400 employs the processing service 408 to manipulate the original shared document and create a specific view of this document which is then sent back to the spectator via the same delivery interface 406. In the preferred embodiment the delivery interface can be implemented as an HTTP request/response method, which is well known in the relevant arts.

Optionally, the manipulated document can be stored in the document cache 410. If a subsequent request is received for the same document with the same viewing preferences, the specific view is extracted from the cache and sent to the spectator bypassing the processing service 408. This particular measure is aimed at reduction of document processing occurring on the host computer.

Implementation

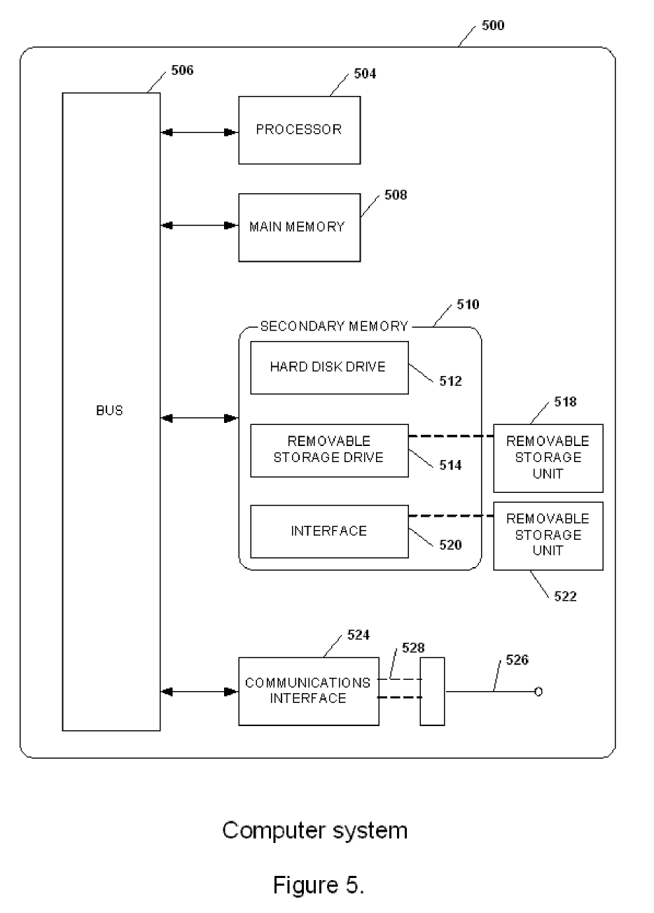

The present invention may be implemented using hardware, software or a combination thereof and may be implemented in a computer system or other processing system. In fact, in one embodiment, the invention is directed toward one or more computer systems capable of carrying out the functionality described herein. An example, a computer system 500 is shown in FIG. 5.

The computer system 500 includes one or more processors, such as processor 504. The processor 504 is connected to a communication bus 506. Various software embodiments are described in terms of this example computer system. After reading this description, it will become apparent to a person skilled in the relevant art how to implement the invention using other computer systems and/or computer architectures.

Computer system 500 also includes a main memory 508, preferably random access memory (RAM), and can also include a secondary memory 510. The secondary memory 510 can include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518, represents a floppy disk, magnetic tape, optical disk, etc. which is read by and written to by removable storage drive 514. The removable storage unit 518 includes a computer usable storage medium having stored therein computer software and/or data.

In alternative embodiments, secondary memory 510 may include other similar means for allowing computer programs or other instructions to be loaded into computer system 500. Such means can include, for example, a removable storage unit 522 and an interface 520. Examples of such include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 518 to computer system 500.

Computer system 500 can also include a communications interface 524. Communications interface 524 allows software and data to be transferred between computer system 500 and external devices. Examples of communications interface 524 can include a modem, a network interface (such as an Ethernet card), a communications port, a PCMCIA slot and card, etc. Software and data transferred via communications interface 524 are in the form of signals which can be electronic, electromagnetic, optical or other signals capable of being received by communications interface 524. These signals 526 are provided to communications interface 524 via a channel 528. This channel 528 carries signals 526 and can be implemented using wire or cable, fiber optics, a phone line, a cellular phone link, an RF link and other communications channels.

In this document, the terms “computer program medium” and “computer usable medium” are used to generally refer to media such as removable storage device 518, a hard disk installed in hard disk drive 512, and signals 526.

These computer program products are means for providing software to computer system 500. Computer programs (also called computer control logic) are stored in main memory 508 and/or secondary memory 510.

Computer programs can also be received via communications interface 524. Such computer programs, when executed, enable the computer system 500 to perform the features of the present invention as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512 or communications interface 524. The control logic (software), when executed by the processor 504, causes the processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While various embodiments of the present invention have been described above, it should be understood that they have been presented by way of example, and not limitation. It will be apparent to persons skilled in the relevant art that various changes in form and detail can be placed therein without departing from the spirit and scope of the invention. Thus the present invention should not be limited by any of the above-described example embodiments, but should be defined only in accordance with the following claims and their equivalents.

1. An on-demand electronic document processing and sharing network comprising:
(a) a server computer,
(b) a host computer,
(c) a server software application installed on said server computer,
(d) a host software application installed on said client computer,
(e) shared electronic documents stored on the host computer,
(f) said server software application comprises
a. a method of communication with host software application on the host computer via a network protocol,
b. a database of links to electronic documents stored on the host computer,
c. an updating means to update said database with links to the electronic documents received from the host computer via said method of communication,
d. a viewer interface providing means to find the links stored in said database and request the electronic documents from the host computer,
e. the viewer interface provides means to directly or indirectly choose viewing preferences, which are submitted along with the request for the electronic documents sent to the host computer,
(g) a host software application installed on said host computers, which comprises
a. a method of communication with server software application on the server computer via a network protocol,
b. a monitoring means to monitor and register changes to the electronic documents stored on the host computer
c. a notification means to notify the server computer software application about such changes to electronic documents via said method of communication,
d. a manipulation means to manipulate electronic documents by transformation of size, dimensions or content, using applicable existing document transformation algorithms, according to the viewing preferences received from the server software application via said method of communication,
e. a delivery interface providing means to deliver the original or transformed electronic documents directly to viewer via a transport protocol,
wherein a viewer connects to the server computer to find the links to the electronic documents, specify the viewing preferences, according to which the electronic documents is automatically processed on the client computer and delivered through said communications method directly from the host computer to said viewer.

2. A system as recited in claim 1 wherein there is a plurality of client computers.

3. A system as recited in claims 2 wherein a single computer serves are both said client computer and said host computer with both the server software program and the client software program and can function as a client computer and process electronic documents.

4. A system as recited in claim 3 wherein there is a plurality of single computers, thus achieving scalability and better performance.

5. A system as recited in claims 1, 2, 3, 4 wherein the electronic document is a digital image.

6. A system as recited in claims 1, 2, 3, 4 wherein the electronic document is a digital video file.

7. A system as recited in claims 1, 2, 3, 4 wherein the electronic document is a text document.

8. A system as recited in claims 1, 2, 3, 4 wherein the electronic document is a digital audio file.

9. A system as recited in claims 1, 2, 3, 4 wherein the electronic document is a file of any special format, for which applicable transformation rules are defined and implemented on the client computer,

10. A system as recited in claims 5, 6, 7, 8, 9 wherein the database of links on the server computer contains small preview images which are stored on the server computer and can be displayed via said user interface to the requesting viewer.

11. A system as recited in claim 1 wherein said communication protocol is SOAP and the method of communication is a Web Service.

12. A system as recited in claim 1 wherein said transport protocol is HTTP and the method of communications is HTTP download.

13. A system as recited in claim 1 wherein said transport protocol is FTP and the method of communications is FTP download.

14. A system as recited in claim 13 wherein said FTP protocol provides client computer's directory browsing capability directly to said viewer.

15. A system as recited in claims 5, 10, 11, 12, 13, 14, wherein viewing preferences are determined automatically based on the client computer's screen resolution and connection speed.

16. A system as recited in claims 1, 3, wherein there is a local cache of processed images on any number of host computers, which is used to serve multiple copies of the same processed document to more than one spectator.
